(19) United States
(12) Patent Application Publication
(10) Pub. No.: US 2024/0331580 A1
(43) Pub. Date: Oct. 3, 2024

(54) LABELS OF LAMINATED PAPER WITH SHRINKABLE OR NON-SHRINKABLE POLYMERIC FILM

(71) Applicants: RITRAMA S.P.A., Caponago (MONZA BRIANZA) (IT); ARCONVERT S.P.A, Arco (TRENTO) (IT)

(72) Inventors: Luciano GALLI, Novate Milanese (MILANO) (IT); Alessandro TRONCONI, Settimo Milanese (MILANO) (IT)

(21) Appl. No.: 18/577,918

(22) PCT Filed: Jul. 8, 2022
(86) PCT No.: PCT/IB2022/056327

§ 371 Date: Jan. 9, 2024

(30) Foreign Application Priority Data
Jul. 9, 2021 (IT) 102021000018050

(51) Int. Cl. G09F 3/00; B32B 7/028; B32B 7/06; B32B 27/10; B32B 27/16; B32B 27/30; B32B 27/32; B32B 27/36; C09J 5/00; C09J 7/29; C09J 7/38; G09F 3/02

(52) U.S. Cl. CPC G09F 3/0291; B32B 7/028; B32B 7/06; B32B 27/10; B32B 27/16; B32B 27/304; B32B 27/32; B32B 27/36; C09J 5/00; C09J 7/29; C09J 7/385; B32B 2255/10; B32B 2255/26; B32B 2255/28; B32B 2307/308; B32B 2307/516; B32B 2307/518; B32B 2307/54; B32B 2307/7166; B32B 2307/72; B32B 2307/736; B32B 2307/748; B32B 2405/00; B32B 2519/00; C09J 2203/334; C09J 2301/122; C09J 2301/302; C09J 2301/502; C09J 2400/283; C09J 2423/046; C09J 2423/106; C09J 2427/006; C09J 2433/00; C09J 2467/006; G09F 2003/0241; G09F 2003/0242; G09F 2003/0273

(57) ABSTRACT

A self-adhesive label includes a bilayer having at least one layer of paper coupled to at least one polymeric film, wherein the polymeric film is coated, on the surface opposite to the surface of coupling to the at least one paper layer, with a layer of pressure sensitive adhesive (PSA). The adhesive has “wash-off” properties such as to cause the label to peel off from a surface by washing with a 1.0%-2.0% NaOH solution at 65-75° C. Alternatively, the adhesive has a force lower than the shrink force of the polymeric film. The label also includes an intermediate layer placed between the polymeric film and the PSA adhesive, capable of promoting the adhesion of the PSA adhesive to the polymeric film, and/or the polymeric film is treated with a corona, flame treatment or plasma treatment.

### FIELD OF THE INVENTION

The present invention relates to a self-adhesive label comprising a bilayer paper/polymeric film with improved removal properties that facilitate recycling or reuse of the labelled article.

### BACKGROUND OF THE INVENTION

In the beverage industry, the containers used, such as glass bottles containing water, beer, wine, soft drinks, etc., are subject to a high reuse rate.

The containers are cleaned on each return before the new filling and the labels, usually made of paper or polymeric film, are peeled off during the cleaning of the containers. Then the containers are filled again and re-labelled with a label corresponding to the new beverage inserted.

Alternatively, the glass containers containing beverages or other liquids are sent for glass recycling, i.e. they are not washed and filled again but the glass of the container is sent to the appropriate recycling plants where it will be melted and reused to prepare new containers. Also in this case the label, usually made of paper or polymeric film, must be removed before the glass can be recycled.

In addition to the beverage industry, the glass or plastic packagings are also very common in other sectors for the packaging of products of any kind, such as foodstuffs, personal care products such as detergents, soaps, shampoos, conditioners, creams, perfumes, etc.

With regard to the plastic containers, the thermoplastic polymers, such as polyethylene terephthalate (PET), are very commonly used in the packaging industry. To most plastic packagings an adhesive label is applied which bears a design, a lettering, the brand of the manufacturer and/or of the product and any information relating to the packaged product. The label may be of paper or, more often, of polymeric material such as polyethylene, polypropylene, polyester, polyethylene terephthalate, polystyrene, polyvinyl chloride. The label adheres to the package by means of a pressure sensitive adhesive (PSA) which is typically acrylic-based.

In order to remove the plastic or paper labels from the glass or polymeric containers, a hot washing liquid is used, such as diluted caustic soda, heated to 60-90° C.

In the case of paper labels, the water permeability of the paper allows the caustic soda solution to penetrate relatively quickly into the entire surface of the label with the result of allowing it to completely peel off during the washing time that is normally of the order of a few minutes. This high permeability to the washing solution is not, however, possessed by the labels in polymeric film. Such labels could prevent access of the washing liquid at the interface between the adhesive surface and the container, with the result that the polymeric labels can only be peeled off slowly from the container.

This inconvenient has been solved by PCT/IB/2021/050187 where a self-adhesive label in polymeric material with a particular distribution of the adhesive in portions placed at a minimum distance between them equal to or higher than 0.5 mm is described. This particular distribution of the adhesive allows the washing solution to easily penetrate in the space between the label and the container and thus allow a faster removal of the labels of polymeric material. PCT/IB/2021/050187 also describes the use of an acrylic-based adhesive having particular wash-off properties such as to cause a paper label to peel off within 3 minutes from a support made of coated paper having a grammage of 80 g/m² by washing it with a solution of 2% NaOH at 75° C., such wash-off properties being measured with the FTM26 method.

Another solution to the problem of the removal of the polymeric labels from the containers when washing the container in order to send it for reuse or recycling is described in U.S. Pat. No. 6,680,097.

This patent discloses a label comprising a support layer of polymeric material which has been subjected to an elongation process in at least one direction and shrinks under the effect of heat, for example by the action of the temperature of the washing solution, so as to overcome the adhesion force of the adhesive layer. In this way, when the label is subjected to heat, the polymer is contracted and the adhesive loses its adhesive force causing the label to peel off from the container in a simple way.

U.S. Pat. No. 6,680,097 indicates that the polymeric label may comprise a polymeric monolayer elongated in mono-axial or bi-axial direction. Alternatively, the label may comprise a plurality of polymeric films, elongated substantially in the same or different direction, which may be co-extruded or bonded together by a lamination adhesive.

U.S. Pat. No. 6,680,097 also describes the possibility of the label to comprise an elongated polymeric layer coupled, by means of a lamination adhesive, to a non-elongated polymeric film, i.e. stable and dimensionally fixed.

This patent does not, however, provide for the possibility of one of the two coupled layers to be a layer of paper.

The paper labels are still very popular especially for the labelling of glass containers as they have a sustainability aspect that is increasingly sought after by the end consumer of any type of product.

In the case of glass, there are several solutions on the market and there is a Finat standardised test, the FTM26 test, which allows evaluating the ability of a paper label to neatly peel off from a support, for example from a glass bottle. The protocol provides for dipping, for a limited time, the labelled support in a hot bath of water and NaOH under stirring.

This test is passed by the paper labels only if the adhesive applied has appropriate wash-off properties.

In many cases, however, the test is not passed, even in the case of usage of adhesive with appropriate wash-off properties, after a certain period of ageing of the label and of the adhesive. This is particularly true when ageing takes place in a humid and cold environment. In these cases, the peel off of the paper label can only take place partially and/or over long times. In this regard, it is assumed that humidity “mobilizes” some substances of the paper, for example mineral fillers, which then interact with the adhesive and do not make it more reactive to the process of peel off in hot caustic soda solution. Among other things, if the print applied on the label is very heavy and with full background or with over-varnish details, that is, with transparent paints applied over the print to make it shinier and/or protect the print itself, all this makes the process even slower and the two factors together (ink barrier and adhesive that interacted with the paper) make the hot removal process completely ineffective.

The need is therefore still felt for a paper label that can overcome the drawbacks illustrated that occur in situations of ageing of the label and of the adhesive.

The present invention provides a paper label for labelling containers of glass or plastic material that overcomes the indicated drawbacks thanks to the lamination of a surface layer of paper with a layer of polymeric film, the latter optionally having shrinkage properties.

Labels are known in the field in which a sheet of paper is laminated with a dimensionally or thermally stable polymeric film or having shrinkable properties from CN110827661 and EP3023968. However, these two patent publications refer to the specific sector of the anti-counterfeiting labels, where the objective to be achieved is that of breaking the surface layer of paper, as this breakage is an indication of infringement of the labelled product. For this reason, the labels of CN110827661 and EP3023968 comprise a fragile system designed to break in case there are attempts to remove the label.

On the contrary, the aim of the label of the present invention is not to break easily. Furthermore, one of the advantages of this invention is that the label can be repositioned in the short term after application, which is usually very difficult with a paper label. The lamination between the paper and the film prevents, in the case of the removal of the label, the breakage of the paper because the tension being exerted is applied to the film.

In addition, the label of CN110827661 has very high thicknesses that are not desirable for the labels that serve to distinguish and/or bear information on the products as they would be perceived by the final consumer as “unsustainable”. The thicknesses mentioned in CN110827661 are high: the shrinkable film has a thickness of 0.1-0.25 mm (100-250 microns), while the adhesive has a thickness of 0.05-0.1 mm (50-100 microns). However, the thicknesses that are desired in the field of labelling of the articles for informational/aesthetic purposes are much lower.

### SUMMARY OF THE INVENTION

In a first aspect, the present invention relates to a self-adhesive label comprising a bilayer comprising (or consisting of) at least one layer of paper coupled to at least one layer of polymeric film by means of a lamination adhesive.

The surface of the polymeric film that is intended to come into contact with the article to be labelled, is coated with a pressure sensitive adhesive (PSA) layer.

The label also comprises a liner in contact with the PSA adhesive. The liner is removed before the label is applied to the article to be labelled.

In one embodiment, the polymeric film has been elongated in at least one direction and shrinks when subjected to heat, for example at the temperature of the washing solution for the containers, exceeding the adhesive force of the adhesive. In other words, the shrink force of the polymeric film is higher than the adhesive force of the adhesive so that the adhesive does not remain attached to the labelled object but is peeled off the object together with the polymeric film of the bilayer.

In this case, the polymeric film preferably comprises or consists of polyethylene terephthalate (PET) or polyvinyl chloride (PVC).

In one embodiment, the polymeric film has not been elongated and therefore is not shrinkable, i.e., is a dimensionally and thermally stable polymeric film. In this case, the polymeric film, preferably, has a density equal to or less than 1 g/cm³ or at 25° C., and is, for example, polypropylene (PP) or polyethylene (PE).

The PSA adhesive is an acrylic adhesive having wash-off properties such as to cause a fast peel off and without leaving substantial residues of a label from a surface, by washing with a 1.0%-2.0% NaOH solution at 65-75° C. according to the FTM26 method of the European Association of the Adhesive Label Industry—FINAT—www.final.com, or according to the protocols QT 500 or QT 508, published by EPBP.

Alternatively, the PSA adhesive is such as to possess an adhesive force less than the shrink force of the polymeric film.

In a preferred embodiment, the label comprises an intermediate layer capable of promoting the adhesion of the PSA adhesive to the polymeric film placed between the polymeric film and the PSA adhesive, and/or the polymeric film is treated with a corona treatment, a flame treatment or a plasma treatment, on the surface opposite to the surface of coupling to the at least one paper layer.

The invention also relates to a film comprising a bilayer comprising (or consisting of) a paper layer coupled, by means of a lamination adhesive, to a polymeric film and having the characteristics described above for the label. A plurality of labels of the invention of different shape and size are obtained from the film by die-cutting the film.

### BRIEF DESCRIPTION OF THE FIGURES

FIG. 1 shows a cross section of the label or of the film of the invention coupled to a liner 6, i.e. before the application to an article;

FIG. 2 shows the label of the invention applied to an article/substrate, i.e. a label in which the liner 6 has been removed and the PSA adhesive is placed in contact with the surface of the article/substrate 7.

FIG. 3 shows the label of the invention applied to an article/substrate, i.e. a label in which the liner 6 has been removed and the PSA adhesive is placed in contact with the surface of the article/substrate 7, wherein the label comprises an intermediate layer 8 comprising a primer.

### DETAILED DESCRIPTION OF THE INVENTION

The label of the invention comprises a bilayer comprising at least one layer of paper coupled to at least one polymeric film. The polymeric film is coated, on the surface opposite to the surface of coupling to the at least one paper layer, with a pressure sensitive adhesive (PSA) layer.

The at least one layer of paper represents the front surface of the label, i.e. the surface that remains visible when the label is applied to an article to be labelled.

Preferably, the at least one paper layer is a paper having a tensile strength of at least 1.8 kN/m transversely and/or longitudinally. Preferably, the tensile strength is comprised between 2.2 kN/m and 3.5 kN/m.

In other words, the paper is not a fragile paper, thereby meaning a paper having a tensile strength less than or equal to 1.8 kN/m.

The at least one paper layer may bear a design and/or a lettering and/or product information applied to the paper layer by conventional techniques known in the art.

Paper is natural paper or coated paper.

The paper layer has a grammage of at least 40 g/m², preferably comprised between 50 and 120 g/m² and a minimum thickness of 40 μm, preferably comprised between 50 and 150 microns.

The at least one paper layer and the at least one polymeric film are coupled with a lamination adhesive that ensures the permanent coupling between the two layers. By permanent coupling between the two layers it is meant that the lamination adhesive has a higher adhesion force than the adhesion force between the PSA adhesive, applied to the polymeric film, and the article on which the label is placed. In this way, the bilayer is removed as a single unit when washing the labelled article to proceed with the recycling thereof.

The lamination adhesive is, for example, a polyurethane-based adhesive, a pressure sensitive adhesive, such as an acrylic-based adhesive, or a heat activatable adhesive.

The polymeric film coupled to the paper layer represents the layer that is placed in contact with the article to be labelled through the PSA adhesive. The polymeric film is a film comprising or consisting of a polymer selected from: polyethylene terephthalate (PET), recycled polyethylene terephthalate (rPET), polyvinyl chloride (PVC), polyester, polyethylene (PE), polypropylene (PP), polyolefins, polylactic acid and polystyrene. The polymeric film may also comprise or consist of a mixture of two or more of the polymers listed above.

In one embodiment, the polymeric film comprises or consists of a polymer having a density of less than or equal to 1 g/ml, and is, for example, polypropylene (PP) or polyethylene (PE).

In one embodiment, the polymeric film is elongated in at least one direction (mono-axial elongation) or is elongated in two directions (bi-axial elongation).

The mono-axial or bi-axial elongation allows the polymeric film to shrink when subjected to heat, returning to the initial shape it had before the elongation. The shrinkage of the polymeric film causes the adhesion force of the PSA adhesive to the article on which the label is applied to be exceeded. In this way, not only the polymeric film is gradually peeled off from the article but also the paper layer, permanently coupled thereto is simultaneously removed, with the result that the entire label can be removed very quickly from the article.

This ease of removal has also been verified for labels that have undergone a certain period of ageing, that is, for those labels applied to an article for a few weeks, preferably for 2 or 3 months, as demonstrated in the experimental part.

The heat applied to the label to cause the polymeric film to shrink may result from washing the labelled article by means of a hot, preferably basic, aqueous solution when recycling the labelled article. The basic solution is preferably an aqueous solution of NaOH, KOH, LiOH, MgOH, CaOH or mixtures thereof.

The concentration of the basic solution is comprised between 1 and 5% by weight of base. For example, the basic solution is a NaOH solution with a concentration comprised between 1 and 5 wt %, preferably 2 wt %.

The basic solution is applied to the article bearing the label for a time equal to or less than 2 hours, preferably equal to or less than 1 hour, more preferably between 1 minute and 1 hour. In one embodiment, the basic solution is applied to the article for a time comprised between 1 minute and 30 minutes, preferably between 1 minute and 20 minutes, more preferably between 1 minute and 10 minutes. In a preferred embodiment, the basic solution is applied for a time equal to 1-8 minutes, preferably 1-5 minutes, more preferably 1-4 minutes.

The labelled article is subjected to washing with the basic solution by dipping the article in the solution. The basic solution is applied to the article at a temperature comprised between 20° C. and 100° C., preferably between 25 and 80° C., preferably between 35 and 50° C. or between 70 and 100° C., preferably between 70 and 80° C.

In one embodiment the basic solution is an aqueous solution of NaOH at a concentration between 1 and 5% by weight applied to the labelled article for a time less than or equal to 5 minutes, preferably less than or equal to 4 minutes, at a temperature between 70 and 100° C., preferably between 70 and 80° C.

Preferably, the shrink force of the polymeric film and the adhesive force of the PSA adhesive to the article are calibrated so as to allow the removal of the label from the article within the times indicated above when a basic solution as described above is used to wash the article. The decrease in the adhesion capacity of the PSA adhesive can be attributed to a decrease in its viscosity when the heat is increased.

The PSA adhesive is preferably an adhesive that does not dissolve in water at least until the label is removed from the container. An example of a PSA adhesive used in the present invention is an acrylic-based adhesive, preferably an acrylate polymer or an acrylate/polyurethane co-polymer.

Preferably, the PSA adhesive comprises acrylic polymers having “wash-off” properties such as to cause a label to peel off from a surface completely (i.e. without leaving substantial residues) and fast by washing with a 1.0%-2% NaOH solution at 65-75° C. according to the FTM26 method of the European Association of the Adhesive Label Industry—FINAT—www.finat.com, or in the case of PET containers, according to the QT 500 or QT 508 protocols published by EPBP (European PET bottle platform). To be defined as “wash-off”, the adhesive must cause the label to peel off in a time less than 10 minutes, preferably less than 3 minutes, more preferably in a time of a few seconds, i.e. in 2-50 seconds, preferably 2-30, more preferably 10-25 seconds.

Alternatively, the PSA adhesive exhibits a force of adhesion to the container less than the shrink force of the polymeric film. By “shrink force” it is meant the force exerted by the film on the adhesive in its heat-shrinkage action. When exposed to heat, in fact, the film shrinks and tends to roll up on itself. This results in a force that tends to peel off the label from the surface of the container.

The PSA adhesive is applied to the back of the polymeric film in such a way as to cover the entire surface or is applied to areas, i.e. to discrete portions. When the label is applied to an article, for example a bottle, which has a certain degree of curvature, the main direction of elongation of the polymeric film may coincide with the direction of the circumference of the article or may be an opposite direction, preferably perpendicular, to the direction of the circumference of the article. In another embodiment, the polymeric film may be elongated in both directions.

Preferably, the percentage of shrinkage of the polymeric film when subjected to heat, at least in the main direction of elongation, is higher than or equal to 5%, preferably higher than or equal to 10%, more preferably between 15 and 20%.

In the embodiment in which the polymeric film is shrinkable, it comprises or consists of polyethylene terephthalate (PET), recycled polyethylene terephthalate (rPET), polyvinyl chloride (PVC), polyester, polyethylene, polypropylene (PP), polyolefins, polylactic acid and polystyrene, preferably polyethylene terephthalate (PET), recycled polyethylene terephthalate (rPET) and/or polyvinyl chloride (PVC).

To ensure that during washing the PSA adhesive remains anchored to the label, the polymeric film on which the PSA layer is applied is preferably treated, prior to the application of the adhesive, with a corona treatment, a flame treatment or a plasma treatment. In other words, the polymeric film is modified with a corona treatment, a flame treatment or a plasma treatment on the surface opposite to the surface of coupling to the at least one paper layer. In this way, the surface of the polymeric film is modified in such a way as to make the adhesive adhere better to the surface. Consequently, during washing, the adhesive remains anchored to the label rather than anchored to the article to be recycled/reused.

Alternatively or in addition, the film may exhibit an intermediate layer capable of promoting the adhesion between the polymeric film and the PSA adhesive, for example comprising ethylene-vinyl acetate, chlorinated polyolefins, polyvinyl chloride derivatives, polymerized ethylene/acrylamide co-monomers, PMMA (polymethylmethacrylate), epoxy resins, melamine resins, or the intermediate layer may comprise a primer e.g. based on an acrylic or polyurethane polymer.

The presence of the treatment and/or of the intermediate layer is useful to ensure that the adhesive remains adhered to the self-adhesive label when the latter is removed during reuse or recycling of the article instead of remaining attached to the article to be recycled or reused.

The polymeric film of the invention preferably has a thickness comprised between 12 and 90 μm, preferably between 35 and 70 μm.

The label of the invention also comprises a liner, preferably in polyethylene terephthalate (PET) or polypropylene (PP) which has a surface in contact with the PSA, wherein said surface is coated with a silicone polymer which allows an easy peel off of the liner from the label before the latter is applied to the article.

In a first embodiment, the invention relates to a self-adhesive label comprising a bilayer comprising (or consisting of) at least one paper layer, as described above, coupled to at least one polymeric film, wherein the polymeric film is a shrinkable film as described above, preferably a PVC or PET film. The polymeric film is coated, on the surface opposite to the surface of coupling to the at least one paper layer, with a pressure sensitive adhesive (PSA) layer. The PSA adhesive layer is protected by a liner that is removed before the label is applied to the article to be labelled.

The coupling of the paper with an elongated polymeric film in at least one direction, capable of shrinking when subjected to heat, is particularly useful in the case where the container on which it is applied is a glass container. In this case, the shrink properties of the polymeric film allow the easy and simultaneous removal of the paper. In this case, in fact, the glass container must be reused and it is therefore important that there is an easy and total peel off of the label.

Preferably, the PSA adhesive comprises acrylic polymers such as to exhibit a force less than the shrink force of the polymeric film. The simultaneous presence of a shrinkable film and a PSA wash-off adhesive makes it possible to obtain an easy and total removal of the label of a container that can thus be reused.

To ensure that during washing the PSA adhesive remains anchored to the label, the polymeric film on which the PSA layer is applied is preferably treated, prior to the application of the adhesive, with a corona treatment, a flame treatment or a plasma treatment.

Alternatively or in addition the film may have an intermediate layer capable of promoting the adhesion between the polymeric film and the PSA adhesive, for example comprising ethylene-vinyl acetate, chlorinated polyolefins, polyvinyl chloride derivatives, polymerized ethylene/acrylamide co-monomers, PMMA (polymethylmethacrylate), epoxy resins, melamine resins, or the intermediate layer comprises a primer e.g. based on an acrylic or polyurethane polymer.

In a second embodiment particularly useful in the case of labelling articles in polymeric material, for example in polyethylene terephthalate (PET), the paper layer is preferably permanently coupled with a non-shrinkable polymeric film, which is coupled with a PSA adhesive having wash-off characteristics as indicated above, preferably such as to cause a label to peel off from an article completely (i.e. without leaving substantial residues on the labelled surface) and fast by washing with a 1.0% NaOH solution—2.0% at 65-75° C. according to the FTM26 method, or according to the QT 500 or QT 508 protocols published by EPBP. To be defined as “wash-off”, the adhesive must cause the label to peel off in a time less than 10 minutes, preferably less than 3 minutes, more preferably in a time of a few seconds, i.e. in 2-50 seconds, preferably 2-30, more preferably 10-25 seconds.

Plastic articles are normally recycled by grinding the article and dipped in a hot alkaline bath where the label is peeled off in short times, thanks also to the wash-off properties of the PSA adhesive.

In the embodiment in which the polymeric film has not been elongated and therefore is not shrinkable, i.e. is a dimensionally and thermally stable polymeric film, the polymeric film preferably has a density equal to or less than 1 g/cm³, preferably less than 0.9 g/cm³, more preferably comprised between 0.6 g/cm³ and 0.9 g/cm³, still more preferably comprised between 0.7 and 0.8 g/cm³ at 25° C.

In this embodiment, the polymeric film has a thickness comprised between 20 and 90 μm, preferably between 20 and 50 μm.

In this embodiment the polymeric film comprises or consists of a polymer selected from polyethylene terephthalate (PET), recycled polyethylene terephthalate (rPET), polyvinyl chloride (PVC), polyester, polyethylene, polypropylene (PP), polyolefins, polylactic acid and polystyrene, preferably between polypropylene (PP) and polyethylene (PE).

To ensure that during washing the PSA adhesive remains anchored to the label, the polymeric film on which the PSA layer is applied is preferably treated, prior to the application of the adhesive, with a corona treatment, a flame treatment or a plasma treatment.

Alternatively or in addition the film may have an intermediate layer capable of promoting the adhesion between the polymeric film and the PSA adhesive, for example comprising ethylene-vinyl acetate, chlorinated polyolefins, polyvinyl chloride derivatives, polymerized ethylene/acrylamide co-monomers, PMMA (polymethylmethacrylate), epoxy resins, melamine resins, or the intermediate layer comprises a primer e.g. based on an acrylic or polyurethane polymer.

In this second embodiment, the bilayer label is removed from the article to which it is applied under the same conditions illustrated above, i.e. by washing with an aqueous solution, preferably a basic, hot one, at the times indicated, thanks to the fact that the PSA adhesive is an adhesive having the wash-off characteristics indicated above. Preferably, in this case the article is ground before proceeding to the removal of the label.

In this second embodiment when the polymeric film is polypropylene (PP) or polyethylene (PE), the density of the label without liner is equal to or less than 1 g/cm³ and therefore when recycling the labelled article, the label floats in the washing solution while the article, which is generally made of PET or of glass or metal, goes down to the bottom. This embodiment therefore also has the advantage of facilitating the recycling of labelled articles by ensuring an effective separation between the label and the article.

In one embodiment, the invention relates to a self-adhesive film comprising a bilayer comprising (or consisting of) at least one paper layer, as described above, coupled to at least one polymeric film, wherein the polymeric film has not been elongated and is therefore not shrinkable or it is elongated and therefore shrinkable, i.e. it is a dimensionally and thermally stable or dimensionally and thermally unstable polymeric film as described above in detail with reference to the label of the invention.

A plurality of labels of the invention of different shape and size are obtained from the film by die-cutting the film.

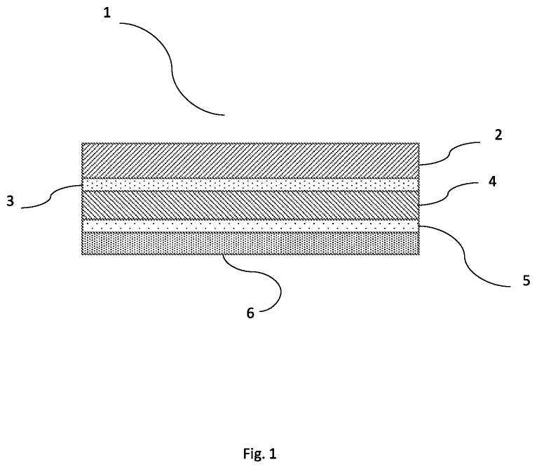

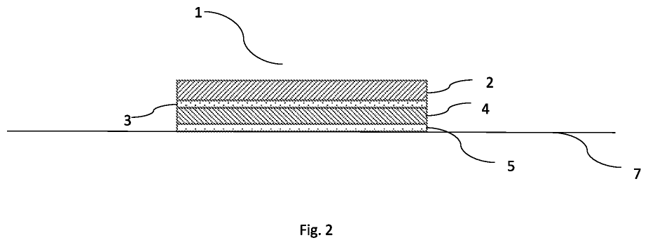

With reference to FIGS. 1 and 2, a label according to the invention is indicated with 1 in which in FIG. 1 there is a liner 6 applied to the adhesive layer PSA 5, while in FIG. 2 the liner is not present and the label is applied to an article 7.

In FIGS. 1 and 2, the layer indicated by the number 2 is the paper layer, while the layer indicated by the number 4 is a shrinkable or non-shrinkable polymeric film. The layers 2 and 4 are permanently laminated by means of a lamination adhesive layer 3. The number 5 represents a layer of PSA adhesive that may have wash-off characteristics as described above.

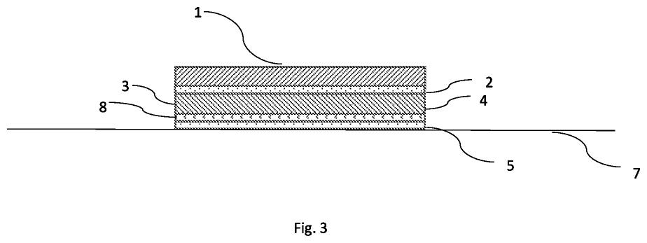

FIG. 3 shows a particularly preferred embodiment in which the label comprises an intermediate layer 8, comprising a primer, placed between the shrinkable or non-shrinkable polymeric film 4 and the PSA adhesive 5.

The total thickness of the label is comprised between 60 and 200 μm.

In all embodiments illustrated in the figures, the PSA adhesive has the wash-off characteristics indicated above or the adhesive has a force less than the shrink force of the polymeric film. In addition, a corona treatment, a flame treatment or a plasma treatment of the polymeric film 4 may be present.

An object of the invention is also a method for removing an adhesive label from an article intended to be recycled or reused comprising:
a) providing an article for recycling or reuse, wherein the article has an adhesive label attached thereto, wherein the label comprises a bilayer comprising (or consisting of) at least one layer of paper, as described above, coupled to at least one polymeric film, wherein the polymeric film has not been elongated and therefore is not shrinkable, i.e. is a dimensionally and thermally stable polymeric film, or the polymeric film is a shrinkable film as described above;
b) subjecting the article to be recycled/reused to a washing with a basic solution for a time equal to or less than 2 hours.

The label further comprises a PSA adhesive as described above applied on the surface of the polymeric film facing the article to be labelled. Preferably, the label comprises an intermediate layer comprising a primer or other polymer promoting the adhesion of the PSA, and/or the shrinkable or non-shrinkable polymeric film is treated with a corona treatment, a flame treatment or a plasma treatment.

The article on which the label is applied is packaging, a package, a bottle, a container or a wrapper and it is made of polymeric material, glass, metal or metal alloys. Preferably, the article is a packaging, e.g. a bottle, for food liquids, such as water, juices, soft drinks, etc., or it is a container for products intended for personal care or for the home, such as for example bottles for detergents, tubes for creams, shampoo, conditioner, etc.

The article to be recycled is an article made of polymeric material or glass or metal.

The polymeric material of the article may be for example polyethylene terephthalate (PET), recycled polyethylene terephthalate (rPET), high density polyethylene (HDPE), polyvinyl chloride (PVC), low density polyethylene (LDPE), polypropylene (PP), polystyrene (PS), polylactic acid (PLA), biopolymers, cellulose, polyester, recycled polyester or mixtures thereof.

The metal can be, for example, aluminium.

In step b) wherein the article bearing the adhesive label is washed in a basic solution, the basic solution is preferably an aqueous solution of NaOH, KOH, LiOH, MgOH, CaOH or mixtures thereof.

The concentration of the basic solution is comprised between 1 and 5% by weight of base. For example, the basic solution is a NaOH solution with a concentration comprised between 1 and 5 wt %, preferably 2 wt %.

The basic solution is applied to the article bearing the label for a time equal to or less than 2 hours, preferably equal to or less than 1 hour, more preferably between 1 minute and 1 hour. In one embodiment the basic solution is applied to the article for a time comprised between 1 minute and 30 minutes, preferably between 1 minute and 20 minutes, more preferably between 1 minute and 10 minutes. In a preferred embodiment, the basic solution is applied for a time equal to 1-8 minutes, preferably 1-5 minutes, more preferably 1-4 minutes.

The labelled article is subjected to washing with basic solution by dipping the article in the solution. The basic solution is applied to the article at a temperature comprised between 20° C. and 100° C., preferably between 25 and 80° C., preferably between 35 and 50° C. or between 70 and 100° C., preferably between 70 and 80° C.

In one embodiment the basic solution is an aqueous solution of NaOH at a concentration between 1 and 5% by weight applied to the labelled article for a time less than or equal to 5 minutes, preferably less than or equal to 4 minutes, at a temperature between 70 and 100° C., preferably between 70 and 80° C.

Step b) of washing with a basic aqueous solution leads to the complete removal of the polymeric label and of the adhesive in very short times and this is due to the presence of a shrinkable polymeric film in the bilayer or to the presence of a dimensionally stable polymeric film (non-shrinkable) and to the presence of an acrylic-based adhesive having wash-off properties such as to cause a label to peel off from a surface completely, that is without leaving substantial residues, and fast by washing with a 1.0%-2.0% NaOH solution at 65-75° C. according to the FTM26 method of the European association of the adhesive label industry—FINAT—www.finat.com, or in the case of PET containers, according to the QT 500 or QT 508 protocols published by EPBP. Alternatively, the PSA adhesive exhibits a force less than the shrink force of the polymeric film.

In one embodiment of the invention, in the case of a plastic article that is to be recycled, before step b) the article to be recycled is ground and then the fragments obtained from grinding are subjected to step b) described above.

### EXAMPLES

The wash-off properties of several labels were tested according to the FTM26 method.

### Label A

Front: 80 g/m² coated paper

Adhesive: Water-based acrylic adhesive for wash off (“A” adhesive) 18 g/m²

### Label B

Front: 80 g/m² coated paper

Adhesive: Water-based acrylic adhesive for wash off (adhesive “B”) 20 g/m²

### Label C

Front: Natural paper 95 g/m² and 135 μm thick laminated with polyurethane lamination adhesive (8 g/m²) to a 45 μm heat-shrinkable PET.

Adhesive: Water-based acrylic adhesive for film (“C” adhesive) 18 g/m²

Presence of a polyurethane primer 0.6 g/m².

The test was performed as follows:
1) Labelling of glass bottles.
2) Wash-off test 7 days after application according to the FTM 26 methodology performed at 75°° C. in the presence of 2% NaOH.
3) Repetition of the test after ageing of a set of bottles in a climatic chamber (45° C., 80% relative humidity) for 7 days.

### Results

| | 7 days at RT | |
|---|---|---|
| | Removal time (s) | Final result |
| LABEL A | 18 | Clean glass |
| LABEL B | 17 | Clean glass |
| LABEL C | 19 | Clean glass |

| | 7 days 45° C. 80% relative humidity | |
|---|---|---|
| | Removal time (s) | Final result |
| LABEL A | >180 s | Failed removal |
| LABEL B | >180 s | Failed removal |
| LABEL C | 100 s | Clean glass |

### Conclusions

The combinations coated paper/adhesive A and B are effectively removed from the glass container according to the wash off protocol FTM26 with water at 75°° C. and 2% NaOH. Ageing in a humid environment, however, alters the behaviour thereof, undermining its wash-off performance.

The label C based on a paper-film front retains its properties even after ageing in a climatic chamber, predictive of 6 months of product useful life.

1-14. (cancelled)

15. A self-adhesive label comprising a bilayer comprising at least one paper layer coupled to the at least one polymeric film, wherein the polymeric film is coated, on a surface opposite to a surface of coupling to the at least one paper layer, with a pressure sensitive adhesive (PSA) layer, wherein a pressure sensitive adhesive (PSA) of the pressure sensitive adhesive layer:
a) comprises acrylic polymers having wash-off properties such as to cause a fast peel off and without leaving substantial residues of the self-adhesive label from a surface, measured under washing conditions with a 1.0%-2.0% NaOH solution at 65-75° C. by the FTM26 method, or by QT 500 or QT 508 protocols published by EPBP; or
(b) the adhesive has an adhesive force less than a shrink force of the polymer film;
and wherein the label comprises an intermediate layer placed between the polymeric film and the PSA adhesive, capable of promoting adhesion of the PSA adhesive to the polymeric film, and/or the polymeric film is treated with a corona treatment, a flame treatment or a plasma treatment, on a surface opposite to a surface of lamination to the at least one layer of paper.

16. The label according to claim 15, wherein said at least one paper layer is a non-fragile paper layer, having a tensile strength of at least 1.8 kN/m.

17. The label according to claim 15, wherein said at least one paper layer and said at least one polymeric film are coupled using a lamination adhesive.

18. The label according to claim 17, wherein the lamination adhesive has an adhesion strength higher than the adhesion strength between the PSA adhesive, applied to the polymeric film, and an article to which the label is applied.

19. The label according to claim 15, wherein the polymeric film comprises a polymer selected from the group consisting of: polyethylene terephthalate (PET), recycled polyethylene terephthalate (rPET), polyvinyl chloride (PVC), polyester, polyethylene, polypropylene (PP), polyolefins, polylactic acid, and polystyrene.

20. The label according to claim 15, wherein the polymeric film is elongated in at least one direction (uniaxial elongation) or is elongated in two directions (bi-axial elongation), and is selected from PET and PVC.

21. The label according to claim 20, wherein the polymeric film shrinks when subjected to heat.

22. The label according to claim 21, wherein the polymeric film shrinks when subjected to washing in a basic solution at a temperature between 20° C. and 100° C.

23. The label according to claim 15, wherein the PSA adhesive exhibits an adhesive force less than the shrink force of the polymeric film.

24. The label according to claim 15, wherein the polymeric film is dimensionally and thermally stable and is a polymeric film having a density of 1 g/cm³ or less at 25° C.

25. The label according to claim 15, wherein the polymeric film comprises polypropylene (PP) and/or polyethylene (PE).

26. The label according to claim 15, wherein said intermediate layer capable of promoting adhesion of the PSA adhesive to the polymeric film comprises ethylvinyl acetate, chlorinated polyolefins, polyvinyl chloride derivatives, polymerized ethylene/acrylamide co-monomers, PMMA (polymethylmethacrylate), epoxy resins, melamine resins, or said intermediate layer comprises a primer that is an acrylic or polyurethane polymer.

27. The label according to claim 15, further comprising a liner applied to the PSA adhesive.

28. A method of removing an adhesive label from an article intended for recycling or reuse, the method including the following steps:
(a) providing an article for recycling or reuse, wherein the article bears an adhesive according to claim 15; and
(b) subjecting the article to be recycled to a washing with a basic solution for a time equal to or less than 2 hours, at a temperature between 20° C. and 100° C.
